(19) United States
(12) Patent Application Publication
(10) Pub. No.: US 2017/0161710 A1
(43) Pub. Date: Jun. 8, 2017

(54) SCANNING THE TAG FOR TRACKING CLOTHING AND ADVERTISING

(71) Applicant: Yi-Hua Su, Taipei City (TW)

(72) Inventor: Yi-Hua Su, Taipei City (TW)

(21) Appl. No.: 15/161,116

(22) Filed: May 20, 2016

Related U.S. Application Data
(60) Provisional application No. 62/163,973, filed on May 20, 2015.

(51) Int. Cl. G06Q 20/20; G06Q 30/06; H04L 29/08; H04W 4/00; H04L 12/58

(52) U.S. Cl. CPC G06Q 20/208; H04W 4/008; H04L 51/32; H04L 67/10; G06Q 30/0645

(57) ABSTRACT

A method of scanning a tag for tracking a cloth by Point of Sale (POS) device during the selling process and the method comprises following steps of:
1) scanning a cloth tag that is attached to cloth for identifying the cloth and transmitting a cloth-identification signal indicating a location of the cloth;
2) renting the cloth to a customer with an option to buy followed by tracking the location of the cloth by receiving the cloth-identification signal from the cloth tag; and
3) managing the availability of the cloth when the customer returns the cloth after a prearranged rental period.

### FIELD OF THE INVENTION

The invention relates to internet of thing (IoT) and more particularly related to tags attached to clothes for wireless communication to track of the rentals, usages and availability at different locations of the clothes.

### 2. DESCRIPTION OF THE RELATED ART

Scanning the tag attached to the merchandizes followed by transmitting and processing the data extracted from the scanning operation is commonly practiced in the product inventory control and sales management. For example, scanning the product tag provides the records of availability of products in different stores, sales and product returns of these products, and all specific information such as brands, sizes, colors, etc. Scanning tags attached to the products for rent provides rental records of the products thus allowing effective management and control of the rental operations.

In the well-known fashion businesses such as Uniqlo, Zara and H&M, scanning of tags attached to clothes are employed to provide data used in retail market for inventory control. Sharing economics concept is achieved by clothing rentals such as LE TOTE in United States, Myonbelle in Germany, and AirCloset in Japan. These rental businesses apply the process of scanning clothing tags to manage the logistics and services for renting the clothes. However, the processes of scanning the clothing tags by these businesses are limited to applying the data obtained by the scanning processes for keeping track of renting and purchasing of the clothes. The processes and operations are quite limited and passive because there are no provisions for proactively linking or actively management of the communications with the customers.

For the above reasons, there is a need to provide new network configurations and improved communication and data processing methods for proactively linking with the customers to provide better services such that the above discussed limitations and difficulties can be resolved.

### SUMMARY OF THE PRESENT INVENTION

One aspect of this invention is to provide a system and method to follow the teachings of the scriptures from Matthew 25:36 “I needed clothes and you clothed me”. In order to achieve this purpose, this invention discloses a method of scanning the tag attached to each piece of cloth for tracking, linking advertising, and actively providing clothes to customers at different locations.

An aspect of the present invention provides the method of scanning the tag for tracking clothing during the selling process by POS (Point of Sale) device comprises following steps of: scanning the clothing tag; tracking the clothing & management; and stop tracking the clothing. The preceding tag includes barcode, QR code, Bluetooth, Radio Frequency Identification (RFID), Near Field Communication (NFC) etc. application. The step: scanning the clothing tag indicates an action of scan the tag for recording clothing data by POS (Point of Sale) device; the clothing data includes brand, style, sizes, price, time, location etc. The step of tracking the clothing then followed by transmitting the data obtained from the tracking to a cloud management system. A real time tracking and management of the availability of clothes in different locations are achieved after the payment process. The step: stop tracking the clothing indicates the cloud management system stop tracking the clothing while the time is out of refund period. As the preceding illustration, the method of the present invention also transfers to a method of scanning the product tag for tracking product comprises following steps of: scanning the product tag; tracking the product & management; and stop tracking the product.

The preceding method of scanning the tag for clothing advertising by POS (Point of Sale) device comprises following steps of: scanning the clothing tag; tracking down social network website of the customer; and automatic posting a content on the social network website. The step: scanning the clothing tag indicates the action of scan the tag is via a POS (Point of Sale) device. The step: tracking down social network website of the customer who has bought or tried on the clothing. The preceding cloud management system tracks down the social network website by relation data of the customer and automatic posting a content on the social network website.

### BRIEF DESCRIPTION OF THE DRAWINGS

FIG 1. is a flow block diagram illustrating the method of present invention according to example embodiments.

FIG. 2 is a flow block diagram illustrating the sub-steps of the method according to example embodiments.

FIG. 3 depicts the sub-steps of the method according to example embodiments.

FIG. 4 depicts the sub-steps of the method according to example embodiments.

FIG. 5 is a flow block diagram illustrating the refund process according to example embodiments.

FIG. 6 is a flow block diagram illustrating the logistic service method according to example embodiments.

FIG. 7 depicts the logistic service method according to example embodiments.

FIG. 8 is a flow block diagram illustrating the method of present invention according to example embodiments.

FIG. 9 depicts the method of present invention according to example embodiments.

FIG. 10 depicts the method of present invention according to example embodiments.

FIG. 11 is a flow block diagram illustrating the method of present invention according to example embodiments.

FIG. 12 depicts the method of present invention according to example embodiments.

### DETAILED DESCRIPTION OF THE PREFERRED EMBODIMENTS

Different embodiments of this invention that implement the systems and methods are described below. The detail descriptions will allow a person of ordinary skill in the art to easily understand the advantages and effects of the present invention disclosed by the specification and drawings of the present invention. Without departing from the foundation of the innovative spirit of the present invention, each embodiment of the present invention can also be modified and changed, or by the realization or applied to different embodiments which are not disclosed in the specification of the present invention. In addition, the details of the embodiments of the present invention could be applied in other applications based on a variety of different points of view.

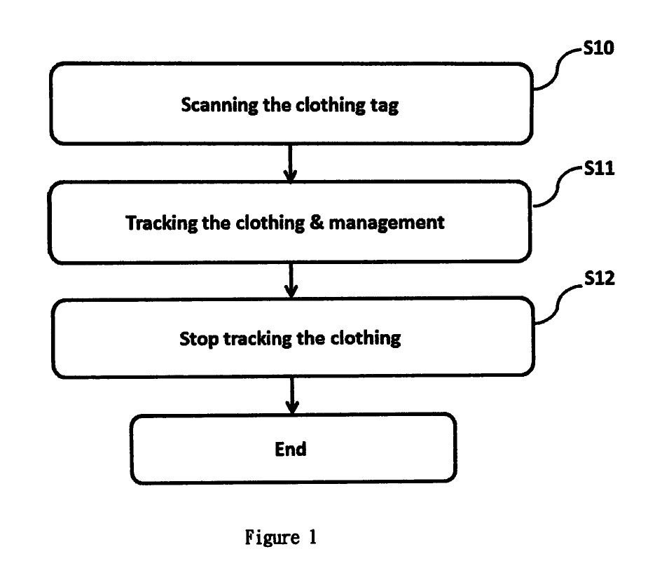

FIG. 1 is a flowchart for illustrating the processes of the first embodiment of the present invention. The method of scanning the tag for tracking clothing and comprises step S10: scanning the clothing tag that indicates the action of scanning the tag by using a POS device for recording clothing data including brand, style, price, time, location etc.; step S11: tracking the clothing & management that indicates a cloud management system connecting with the POS device by network and tracking the clothing location & management; and step S12: stop tracking the clothing that indicates the cloud management system has completed the tracking and managing the clothing.

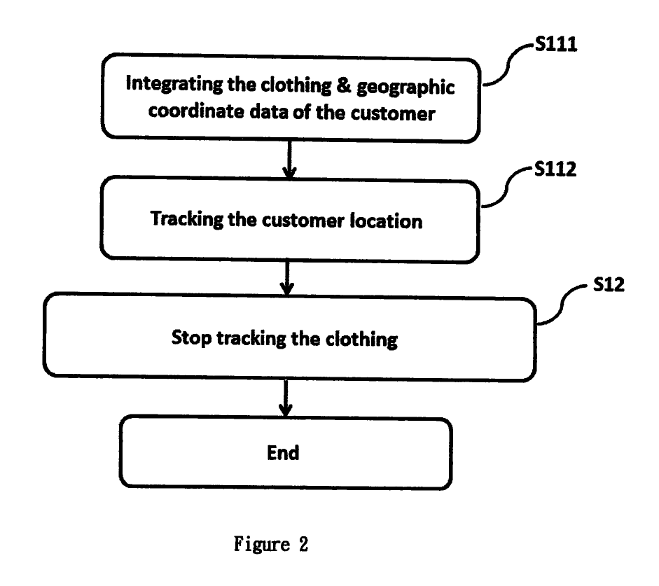

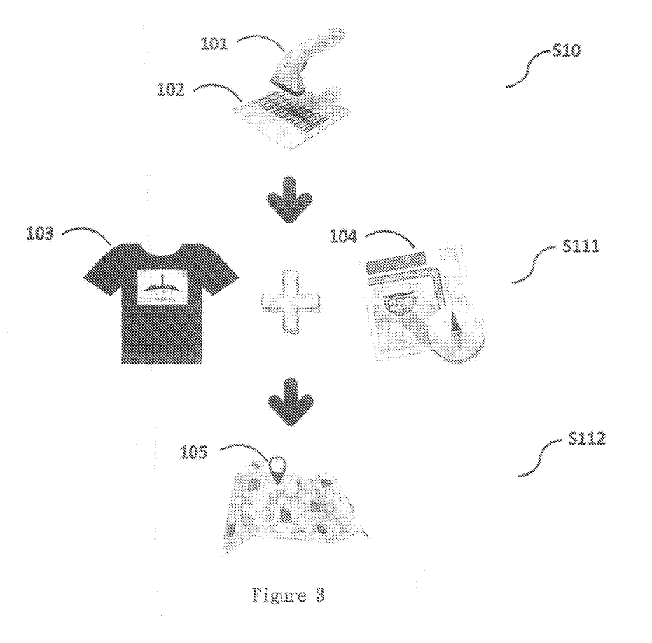

FIG. 2 is a flow block diagram to illustrate the processing step of step S11, the step of tracking the clothing & management, wherein this step further comprises two sub-steps S111: integrating the clothing data and the geographic coordinate data of the customer; and S112: tracking the customer location, the POS device and the cloud management system complete both the two sub-steps. The customer completed the payment process with options of cash payment, credit card or contactless payment. The payment process provides data for keeping track and recording the customer data. The preceding two sub-steps S111 and S112 are as illustration in FIG.3, Step S10 shows the POS device 101 scanning the clothing tag 102 for recording the clothing data 103, Sub-step S111 shows the clothing data 103 combines with geographic coordinate data 104 of the customer, Sub-step S112 shows tracking the customer location 105.

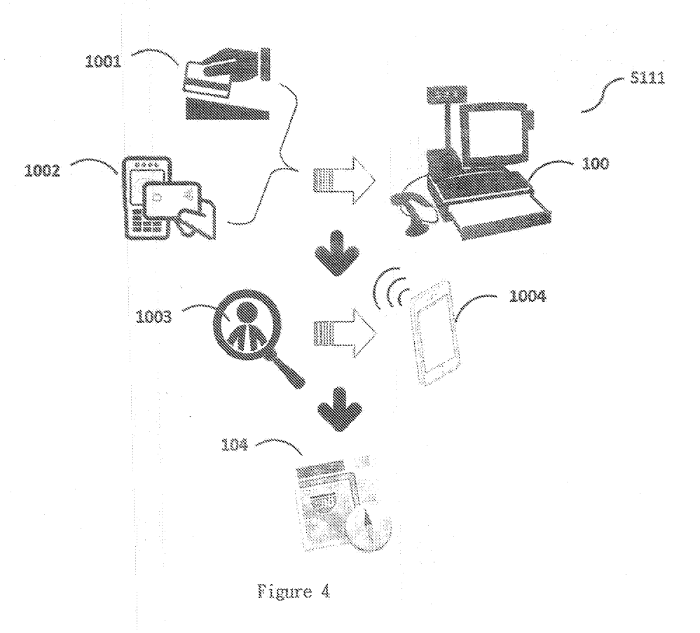

FIG. 4 is an illustrative diagram that depicts the POS device 100 to receive and record the data concerning the mobile phone 1004 of the customer 1003. The POS device further receives and record data from the credit card 1001 or contactless payment 1002. Specifically, the wireless signals include GPS, telecom register, Wi-Fi and Bluetooth signals. The cloud management system uses the telecom algorithm by the POS device 100 to transfer signals of geographic coordinate data 104 of the customer 1003. Sub-step 5111 carries out the process of integrating the clothing and geographic coordinate data of the customer followed by transmitting the tracking data of the customer 1003 to a cloud management system. The cloud management system applies the customer data to complete sub-step S112 that performs the processes of tracking the customer location. When a rented cloth is out of the refund period, the cloud management system performs step S12 to stop tracking the clothing since the customer is no longer intend to exercise the returning option after the expiration of the refund period. The above processes as illustrated can also be carried out by the customer who bought or rent the clothing online by E-commerce.

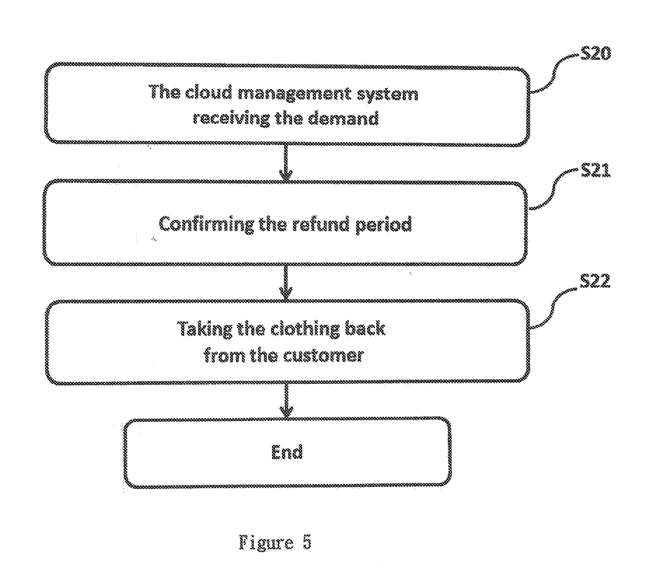

FIG. 5 is a flowchart to illustrate a second embodiment of this invention. In this embodiment, a customer send a request by a mobile phone or a computer to return the cloth to initiate a refund process comprises step S20: the cloud management system receiving the demand; step S21: the management system confirms the refund period; while the demand is in the refund period and step S22: the cloud management system directly performs a process of taking the cloth back from the customer.

In the above descriptions, the cloud management system receives the tracking data from the telecom algorithm via the mobile phone signals, and then a logistic service takes the cloth back from the customer by the tracking data. While the demand is out of the refund period, the cloud management system notifies the customer to pay a refund reactivated fee, after the customer paid off the fee, the cloud management system performs step S22, then the logistic service takes the clothing back from the customer location by the tracking data.

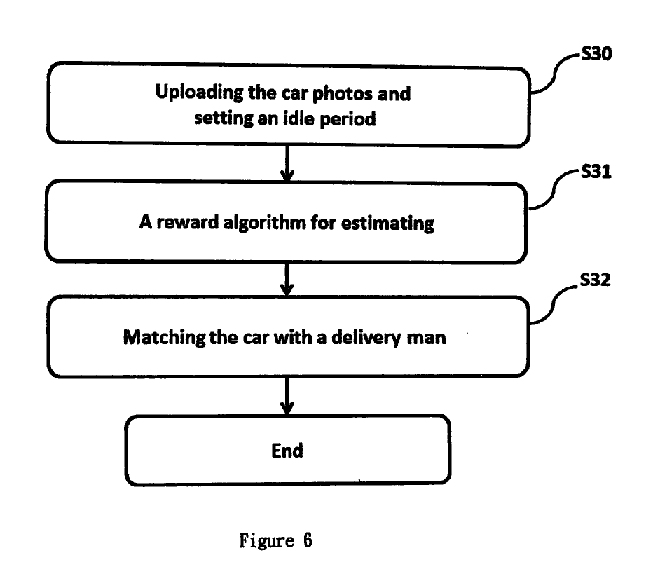

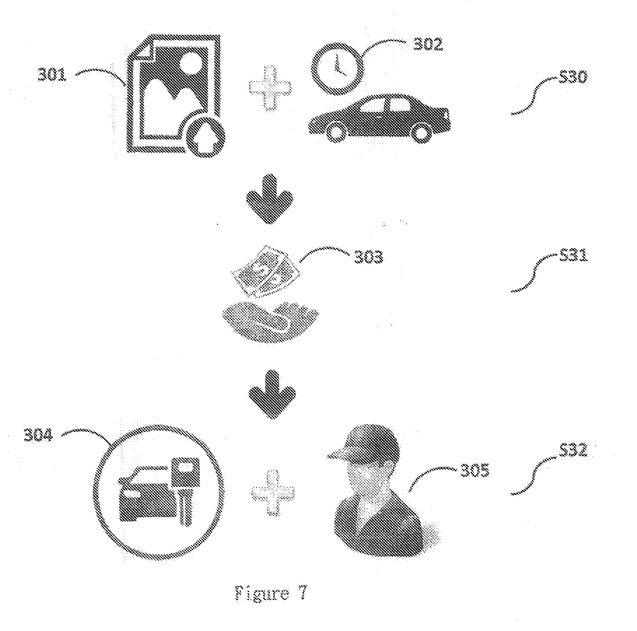

FIG. 6 is a flowchart of processes as another embodiment of this invention implemented to improve the efficiency of the logistic service. FIG. 6 is a method for taking an idle car for implementing a logistic service by receiving and processing mobile phone signals. Specifically, the method indicates a private car that can be confirmed as an idle car. The confirmed idle car is available for transferring to another drive to provide logistic service during a long parking time. Similar to the cloth renting processes disclosed in this invention, the idle period either of a car, a cloth, or other serviceable objects can be allotted or apportioned as available time slots that can be rented out for service to a renter within the allotted available time period. Accordingly, the method comprises step S30 to carry out the processes of uploading the car photos and setting an idle period. In step S31 a reward calculation algorithm is performed to estimate the rental rate. In step S32 the available car and the location and time of the available idle car is matched with the delivery man. FIG.7 is an illustrative diagram wherein in step S30 the photo of the car 301 together with a preset available period 302 is uploaded to the cloud management system. The upload process may be carried out by using the mobile phone signals. In specific embodiments, the car photos 301 include exterior view, license plate of car (car registration), insurance etc. According to information of the car photos 301 the cloud management system links with the car management database of government to get the car detail data, finally the cloud management system integrates the car detail, the idle period 302 and the mobile phone signals to an idle car 304 data. In Step S31: a reward algorithm for estimating a rental payment is carried out. The cloud management system estimates a rental payment 303 according to the idle car 304 data and the logistic service requirement by the reward algorithm to make payment to the car owner 305.

As described above in FIG.7, the mobile phone signals include GPS, telecom register, Wi-Fi and Bluetooth signals. The telecom signal analysis process analyzes the mobile phone signals to determine the geographic locations a mobile phone user. According to mobile phone signals of the idle car 304 data the cloud management system determines the idle car 304 parking location by the telecom algorithm then matches the idle car 304 with the delivery man 305. In order to protect the owner and the driver, an insurance platform of the cloud management system is setup to insure the car during the allotted rental period for the idle car 304. In step S32 after the process of matching the car with the delivery man, another driver as the renter of the car replaces the delivery man 305 to drive the car during the allotted rental period of the idle car. Thus the usage of the car is greatly increased with dynamically allocation of rentable time slots to rent the car during a prolong idle time of the car.

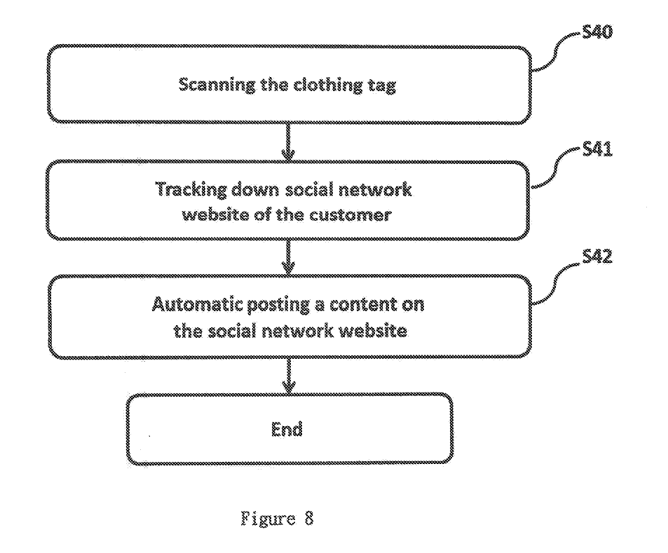

FIG. 8 is a flowchart to illustrate the processes according to a fourth embodiment of the present invention. In this embodiment, a process of scanning the tag for cloth is first performed in step S40. Then a step S41 is carried out to search and obtain the social network website of the existing customers who have either purchased or rented the cloth or similar clothes in the past. In step S42 an automatic posting contents of advertisement on the social network website is performed.

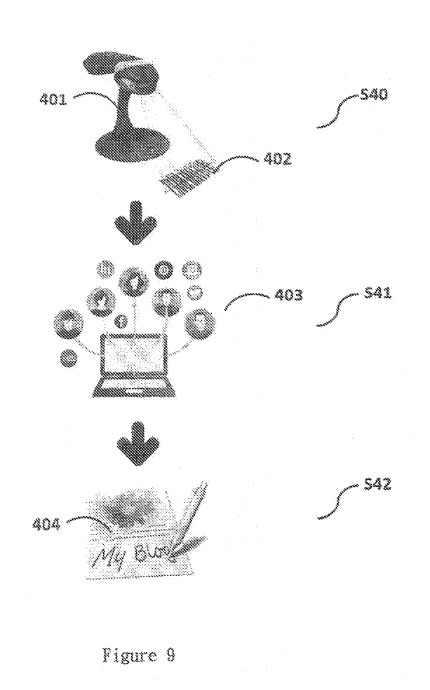

FIG. 9 is an illustrative diagram to show some specific details of the embodiment shown in FIG. 8. In step S40 a scanning process of a clothing tag 402 by the POS device 401 is performed to obtain data of a cloth that may include brand, style, price, time, location etc. In step S41 a search process is performed to find out the available social network websites 403 of the customer according to the information of the customer obtained by the POS device 401. The POS device 401 connects with the cloud management system via network to search the customer data including the name, mobile phone number, E-mail etc. by the credit card 1001 or contactless payment 1002, then the cloud management system tracks down social network website 403 of the customer. The preceding social network website 403 of the customer is for existing customers who bought or tried on the clothes managed by the cloud management system. In step S42, after the clothing is brought or tried on, the cloud management system automatically posts contents 404 on the social network website 403. The social network website 403 may include the websites of the customer social network and the clothing social network websites 403.

Referring to FIG. 9, wherein step S42 carries out the processes of automatic posting contents on the social network website. The posted contents may include pictures posted by the cloud management system with texts to explain or describe the contents 404. The contents may be uploaded from the clothing gallery or the mobile phone storage. The contents may be posted by the customer to confirm or update the content 404 posted on social network website 403 of the customer. For example: “I bought a Giorgio Armani suit in Taipei 101.” on social network website 403 of the customer. Or “Mr. Su bought a Giorgio Armani suit in Taipei 101.” on the clothing social network website 403. Furthermore the contents may include comic, video, animation etc.

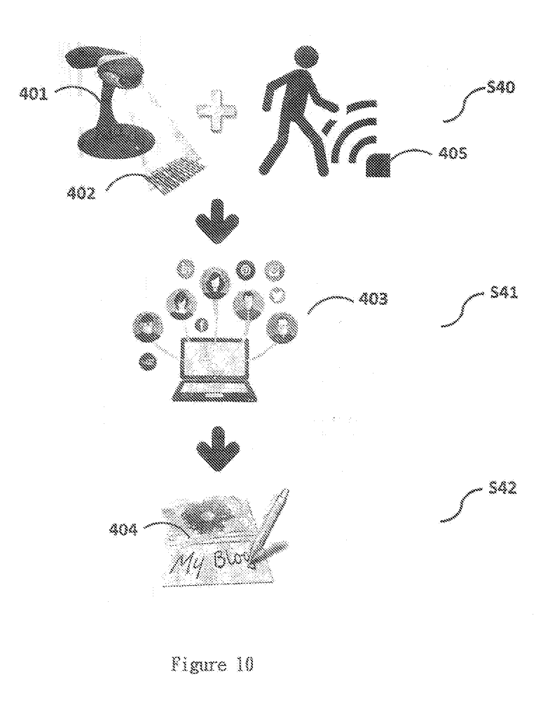

FIG. 10 is an illustrate diagram to depict a fifth embodiment of this invention. Under the circumstances when the customer has not completed payment of the clothing, the POS device 401 performs step S40: scanning the clothing tag, then the customer brings the clothes to a fitting room to try on. Before trying on the clothing the customer passes a sensor 405 connecting with the POS device 401 and the cloud management system via network. The sensor 405 detects mobile phone signals of the customer and communicates with the cloud management system. The cloud management system carries out a search to find out a social network website 403 of the customer from the data obtained by the sensor 405. In Step S42 the cloud management system automatically posts a content on the social network website. The contents posted by the cloud management system may include a picture and texts to explain or describe the content 404. The picture may be taken from the clothing gallery or the mobile phone storage. The customer may confirm or update the content 404 posted on social network website 403 of the customer. For examples: “I tried on a Giorgio Armani suit in Taipei 101.” on social network website 403 of the customer. Or “Mr. Su tried on a Giorgio Armani suit in Taipei 101.” on the clothing social network website 403.

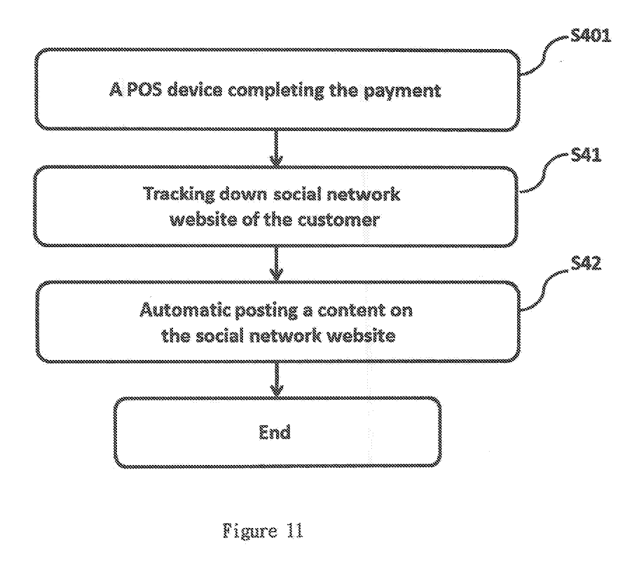

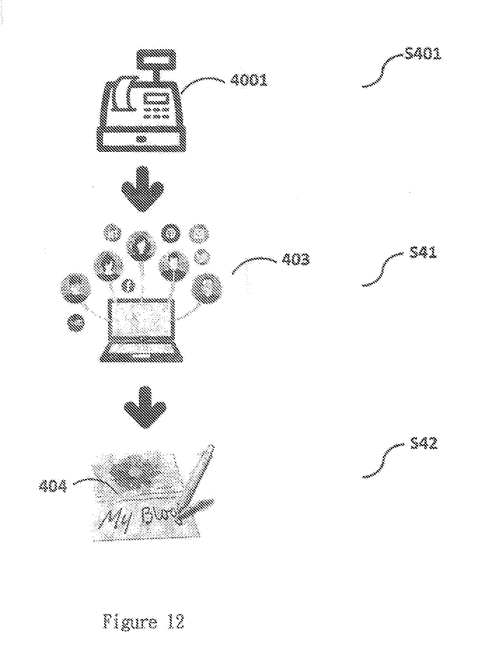

FIG. 11 is a flowchart that illustrates the processes performed by a sixth embodiment of this invention. In step S401, a payment process carried out in a restaurant wherein a POS device receives a payment from a credit card 1001 or a contactless payment 1002. Referring to FIG. 12, the cloud management system obtains or searches the mobile phone data of the customer according to information receives from the POS device 4001 and completes step S41 for finding the social network website of the customer. In Step S42, the cloud management system automatically posts a content on the social network website. The cloud management system may a post a picture with texts to describe or explain the contents 404. The picture may be taken from the restaurant or the mobile phone storage. The customer may confirm or update the content 404 posted on social network website 403 of the customer. For examples: “I have a cup of Cappuccino at Starbucks of Taipei 101.” on social network website 403 of the customer. Or “Mr. Su has a cup of Cappuccino at Starbucks of Taipei 101.” on the café shop social network website 403. The cloud management system receives the payment data of the customer from the POS device 4001 performing step S401: a POS device completing the payment.

This invention discloses a method of scanning a tag for tracking a cloth by Point of Sale (POS) device during the selling process and the method comprises following steps of: 1) scanning a cloth tag that is attached to cloth for identifying the cloth and transmitting a cloth-identification signal indicating a location of the cloth; 2) renting the cloth to as customer with an option to buy followed by tracking the location of the cloth by receiving the cloth-identification signal from the cloth tag; and 3) managing the availability of the cloth when the customer returns the cloth after a prearranged rental period. In an alternate embodiment, the method further includes a step of obtaining customer data from the customer and establishing an integrated database comprises the customer data, the location of the cloth transmitted from the cloth tag and data stored in the cloth tag. In another embodiment, the step of obtaining the customer data further comprising a step of obtaining a customer's social network website for posting a content related to the cloth on the customer's social network website. In another embodiment, the step of obtaining the customer data further comprises a step of obtaining the customer data by using a point-of-sale (POS) device. In another embodiment, the step of obtaining the customer data further comprising a step of obtaining a customer's mobile phone number by using a sensor disposed in a store.

According to above descriptions, this invention further discloses a method for renting and utilizing a privately-owned automobile comprising: 1) an owner determining a rentable period of the privately-owned automobile; 2) transmitting the rentable period and contents related to the privately-own automobile to a networked public domain; and 3) receiving requests to rental the privately-owned automobile during the rentable period followed by arranging rental logistics for renting the privately-owned automobile. In another embodiment, the step of arranging the rental logistics for renting the privately-owned automobile further comprises a step of arranging a first driver to drive the privately-owned automobile from a location of the privately-owned automobile to a renter designated location for the renter to conveniently drive the privately-owned automobile during the rentable period, in another embodiment, the step of arranging the rental logistics for renting the privately-owned automobile further comprises a step of arranging a second driver to drive the privately-owned automobile from a renter's location of the privately-owned automobile to a owner designated location for the renter to conveniently return the privately-owned automobile at an end of the rentable period. In another embodiment, the step of arranging the rental logistics for renting the privately-owned automobile further comprises a step of attaching an electronic tag to the privately-owned automobile for transmitting a location and operation status of the privately-owned vehicle. In another embodiment, the step of attaching an electronic tag to the privately-owned automobile further comprises a step of placing a wireless communication device in the privately-owned automobile for transmitting a location and operation status of the privately-owned vehicle.

In summary, this invention further discloses a method for renting and utilizing a privately-owned serviceable object. The method includes steps of 1) determining a rentable period of the privately-owned serviceable object; 2) transmitting the rentable period and contents related to the privately-own serviceable object to a networked public domain; and 3) receiving requests to rental the privately-owned serviceable object during the rentable period followed by arranging rental logistics for renting file privately-owned serviceable object.

Although the present invention has been described in terms of the presently preferred embodiment, it is to be understood that such disclosure is not to be interpreted as limiting. For example, though the conductivity types in the examples above often show an n-channel device, the invention can also be applied to p-channel devices by reversing the polarities of the conductivity types. Various alterations and modifications will no doubt become apparent to those skilled in the art after reading the above disclosure. Accordingly, it is intended that the appended claims be interpreted as covering all alterations and modifications as fall within the true spirit and scope of the invention.

I claim:

1. A method of scanning a tag for tracking a cloth by Point of Sale (POS) device during the selling process and the method comprises following steps of:
scanning a cloth tag that is attached to cloth for identifying the cloth and transmitting a cloth-identification signal indicating a location of the cloth;
renting the cloth to a customer with an option to buy followed by tracking the location of the cloth by receiving the cloth-identification signal from the cloth tag; and
managing the availability of the cloth when the customer returns the cloth after a prearranged rental period.

2. The method according to claim 1 further comprising:
obtaining customer data from the customer and establishing an integrated database comprises the customer data, the location of the cloth transmitted from the cloth tag and data stored in the cloth tag.

3. The method according to claim 2, wherein:
the step of obtaining the customer data further comprising a step of obtaining a customer's social network website for posting a content related to the cloth on the customer's social network website.

4. The method according to claim 2, wherein:
the step of obtaining the customer data further comprising a step of obtaining the customer data by using a point-of-sale (POS) device.

5. The method according to claim 2, wherein:
the step of obtaining the customer data further comprising a step of obtaining a customer's mobile phone number by using a sensor disposed in a store.

6. A method for renting and utilizing a privately-owned automobile comprising:
an owner determining a rentable period of the privately-owned automobile;
transmitting the rentable period and contents related to the privately-own automobile to a networked public domain; and
receiving requests to rental the privately-owned automobile during the rentable period followed by arranging rental logistics for renting the privately-owned automobile.

7. The method of claim 6 wherein:
the step of arranging the rental logistics for renting the privately-owned automobile further comprising a step of arranging a first driver to drive the privately-owned automobile from a location, of the privately-owned automobile to a renter designated location for the renter to conveniently drive the privately-owned automobile during the rentable period.

8. The method of claim 6 wherein:
the step of arranging the rental logistics for renting the privately-owned automobile further comprising a step of arranging a second driver to drive the privately-owned automobile from a renter's location of the privately-owned automobile to a owner designated location for the renter to conveniently return the privately-owned automobile at an end of the rentable period.

9. The method of claim 6 wherein:
the step of arranging the rental logistics for renting the privately-owned automobile further comprising a step of attaching an electronic tag to the privately-owned automobile for transmitting a location and operation status of the privately-owned vehicle.

10. The method of claim 9 wherein:
the step of attaching an electronic tag to the privately-owned automobile further comprises a step of placing a wireless communication device in the privately-owned automobile for transmitting a location and operation status of the privately-owned vehicle.

11. A method for renting and utilizing a privately-owned serviceable object comprising:
determining a rentable period of the privately-owned serviceable object;
transmitting the rentable period and contents related to the privately-own serviceable object to a networked public domain; and
receiving requests to rental the privately-owned serviceable object during the rentable period followed by arranging rental logistics for renting the privately-owned serviceable object.
